(19) United States
(12) Patent Application Publication
(10) Pub. No.: US 2017/0095867 A1
(43) Pub. Date: Apr. 6, 2017

(54) WORKPIECE SUPPORT DEVICE FOR CIRCULAR SAW

(71) Applicant: REXON INDUSTRIAL CORP., LTD., Taichung (TW)

(72) Inventor: Chih-Chin HSU, Taichung (TW)

(21) Appl. No.: 15/281,206

(22) Filed: Sep. 30, 2016

(30) Foreign Application Priority Data
Oct. 2, 2015 (TW) 104132563

(51) Int. Cl. B23D 47/02; B27B 5/29

(52) U.S. Cl. CPC B23D 47/025; B27B 5/29

(57) ABSTRACT

A workpiece support device for circular saw having a guide shaft axially and slidable inserted with one end thereof into the worktable of the circular saw, a support member affixed to an opposite end of the guide shaft and providing a first support plane co-planar with the work surface of the worktable, and an auxiliary support arm mounted at the support member and movable relative to the support member in a direction perpendicular to the axial direction of the guide shaft and providing a second support plane co-planar with the first support plane of the support member. Thus, the workpiece support device mates with the worktable to provide sufficient support to a large size workpiece.

### BACKGROUND OF THE INVENTION

1. Field of the Invention

The present invention relates to circular saw technology and more particularly, to a workpiece support device for use in a circular saw.

2. Description of the Related Art

In order to carter for different size workpieces, a circular saw generally has a workpiece support device mounted at each of the two opposite sides of the worktable thereof for providing a supplementary support to the workpiece on the worktable. As illustrated in FIG. 1, the prior art workpiece support device 1 mainly comprises two guide shafts 2 and a support member 3. Each guide shaft 2 has one end thereof axially slidably mounted in the worktable 4, and an opposite end thereof fixedly connected with the support member 3. Thus, when the length of the workpiece is excessively large, the operator can move the guide shafts 2 axially to adjust the position of the support member 3, enabling the support member 3 to support the workpiece on the worktable 4.

Although the position of the support member 3 is adjustable according to the length of the workpiece to be cut, it is not effective for supporting other type workpieces (such as large size workpieces). When a large size workpiece is placed on the worktable, the part of the large size workpiece that protrudes over the front side of the workpiece support device 1 and disposed outside the worktable 4 will be suspended in the air without any support, thus, it is bound to seriously affect the stability and the precision of the cutting operation.

### SUMMARY OF THE INVENTION

The present invention has been accomplished in view of the disadvantages of the prior art support devices. It is one of the main objects of the present invention to provide a workpiece support device for a circular saw, which effectively assists the worktable to support a large sized workpiece, to enhance working stability and the precision of the cutting operation.

To achieve this and other objects of the present invention, a workpiece support device is adapted for use in a circular saw. The workpiece support device comprises a guide shaft, a support member and an auxiliary support arm. The guide shaft has one end thereof axially movably mounted in the worktable of the circular saw. The support member is fixedly mounted at an opposite end of the guide shaft for synchronous movement with the guide shaft. Further, the support member comprises a first support plane co-planar with the work surface of the worktable to provide a support effect. The auxiliary support arm mounted in the support member and movable relative to the support member along an operation direction perpendicular to the axial direction of the guide shaft. Further, the auxiliary support arm comprises a second support plane co-planar with the first support plane of the support member to mate with the worktable for supporting a large size workpiece.

In a first embodiment of the present invention, the support member comprises a screw hole extended in parallel to the axial direction of the guide shaft; the auxiliary support arm comprises a guide slot extended perpendicular to the axial direction of the guide shaft, and a screw bolt inserted through the guide slot and threadable into the screw hole of the support member to lock the auxiliary support arm to the support member. Thus, when the screw bolt is loosened, the auxiliary support arm can be moved in an operation direction to a working position. Thereafter, the screw bolt is fastened tightly to lock the auxiliary support arm in the working position.

In a second embodiment of the present invention, the support member comprises a through hole extended perpendicular to the axial direction of the guide shaft, and a flange extended around the through hole; the auxiliary support arm comprises a retainer groove extended around the periphery thereof, and a retaining ring mounted in the retainer groove and stoppable against the flange of the support member to prohibit the auxiliary support arm from being removed from the through hole. When the auxiliary support arm is pulled outward along the operation direction, the retaining ring will be synchronously moved with the auxiliary support arm. Once the retaining ring is stopped against the flange of the support member, the auxiliary support arm is positioned in the working position.

Other and further advantages and features of the present invention will be understood by reference to the following specification in conjunction with the accompanying drawings.

### BRIEF DESCRIPTION OF THE DRAWINGS

FIG. 1 is an oblique top elevational view of a circular saw according to the prior art.

FIG. 2 is an oblique top elevational view of a workpiece support device incorporated circular saw according to the present invention (the cutting device excluded).

FIG. 3 is an oblique top elevational view of a workpiece support device for circular saw in accordance with a first embodiment of the present invention.

FIG. 4 is an exploded view of the workpiece support device in accordance with the first embodiment of the present invention.

FIG. 5 is an oblique top elevational view of a workpiece support device for circular saw in accordance with a second embodiment of the present invention.

FIG. 6 is an exploded view of the workpiece support device in accordance with the second embodiment of the present invention.

FIG. 7 is a sectional view of the workpiece support device in accordance with the second embodiment of the present invention, illustrating the auxiliary support arm in a received position.

FIG. 8 is similar to FIG. 7, illustrating the auxiliary support arm in an extended working position.

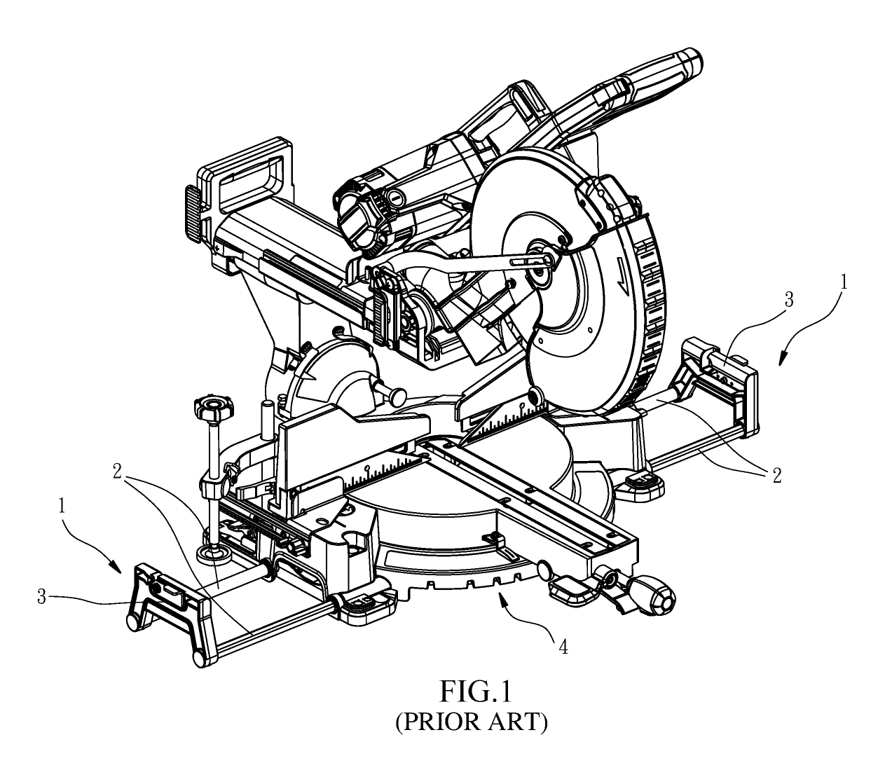

### DETAILED DESCRIPTION OF THE INVENTION

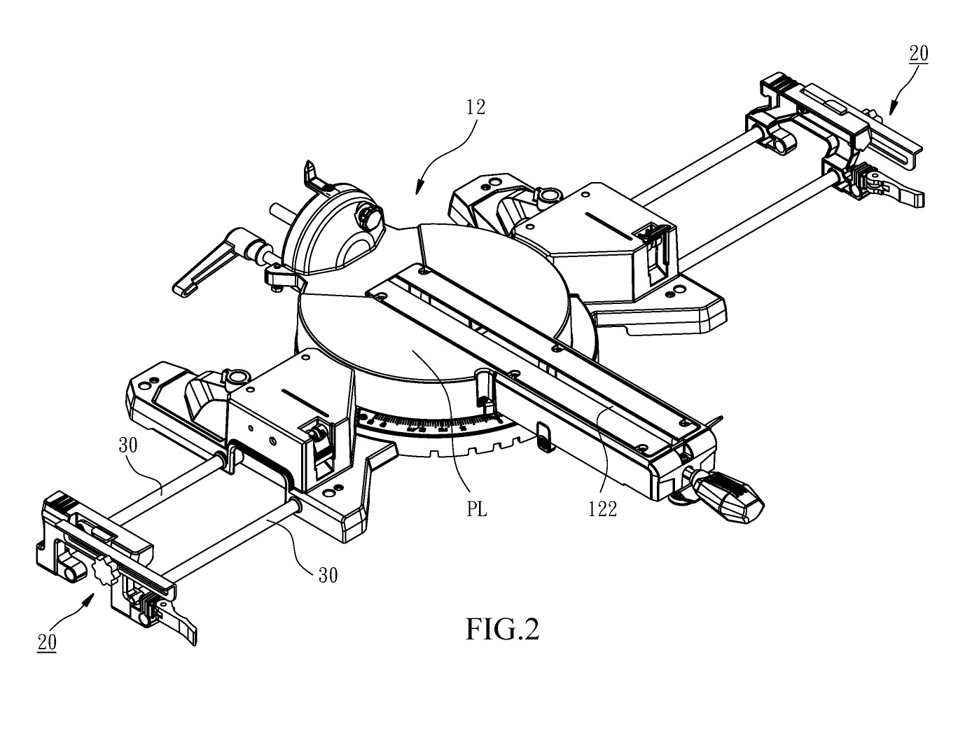

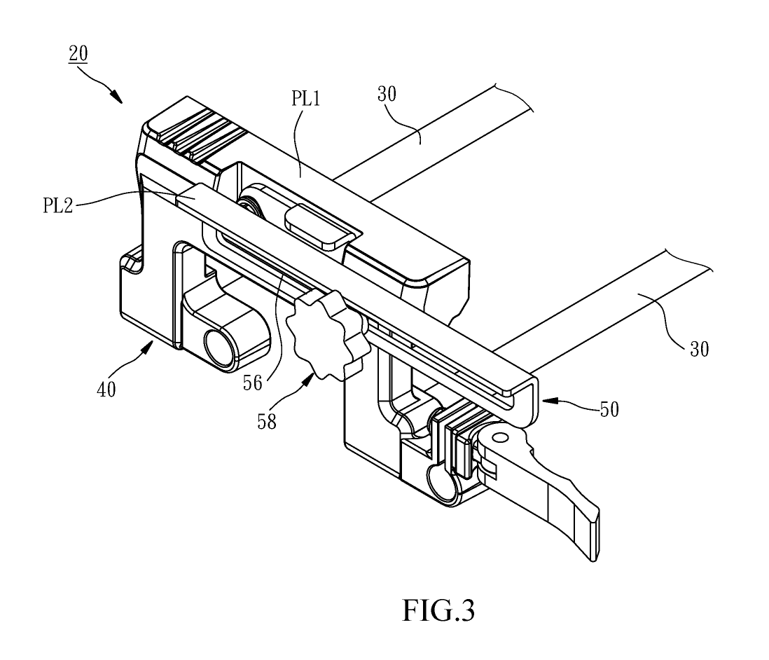

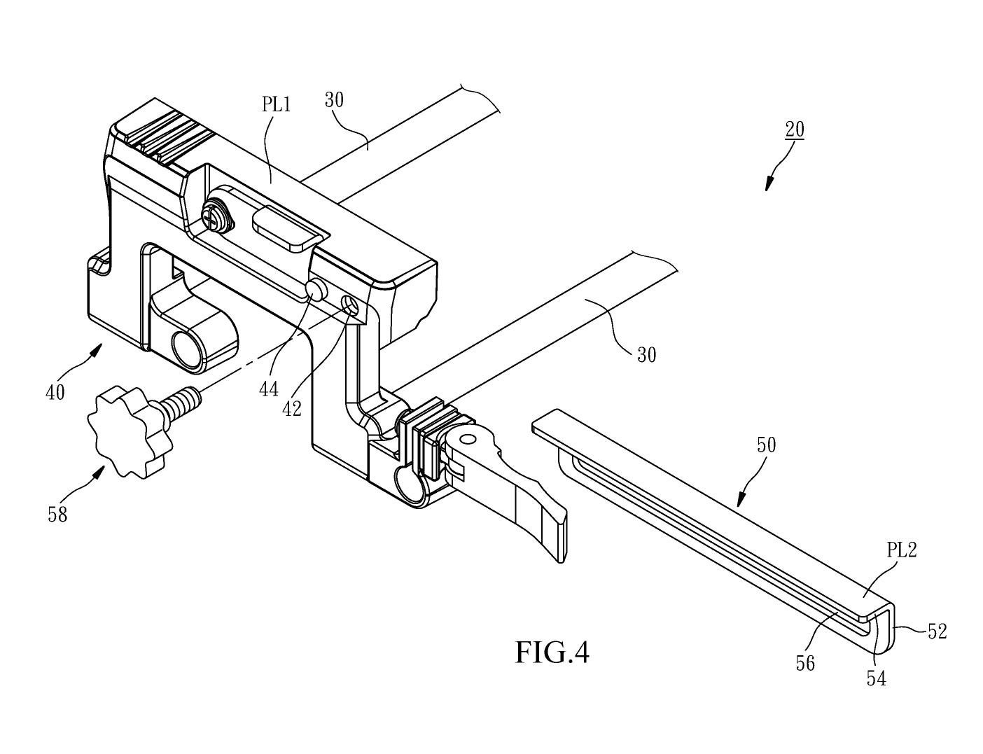

Referring to FIG. 2, a workpiece support device 20 in accordance with a first embodiment of the present invention is shown used in a circular saw 10. The circular saw 10 comprises a worktable 12. The worktable 12 comprises a work surface PL, and a saw blade slot 122 cut through the work surface PL. The work surface PL is adapted for carrying a workpiece (not shown). The saw blade slot 122 is adapted for the insertion of a saw blade (not shown) during a cutting operation. Because the circular saw 10 is of the known tool and not within the scope of the present invention and in order to save space, the structural details and operating principle of the circular saw 10 will not be discussed here. Further, in actual application, two workpiece support devices 20 are symmetrically mounted at two opposite sides of the worktable 12. Because these two workpiece support devices 20 are completely identical in structure, one single workpiece support device 20 is taken for explanation so as to safe space. As illustrated in FIG. 3 and FIG. 4, the workpiece support device 20 comprises two parallel guide shafts 30, a support member 40, and an auxiliary support arm 50.

The axial direction of the guide shafts 30 extends perpendicular to the extending direction of the saw blade slot 122 of the worktable 12. Each guide shaft 30 has one end thereof axially movably inserted into the worktable 12, as well known in the art. For example, the guide shaft(s) 30 are slidable through channels or holes in the worktable or on an underside thereof having an end stop on an end of the guide shaft.

The support member 40 is fixedly connected to respective other ends of the two guide shafts 30 so that the support member 40 and the two guide shafts 30 are synchronously movable. The support member 40 defines a first support plane PL1 on a top side thereof. The first support plane PL1 is co-planar with the work surface PL of the worktable 12, assisting the worktable 12 to support the workpiece. Further, in this first embodiment, the support member 40 comprises a screw hole 42 located on an outer lateral side thereof, and a guide rod 44 disposed adjacent to the screw hole 42. The axial direction of the screw hole 42 extends in parallel to the axial direction of the guide shafts 30.

The auxiliary support arm 50 comprises a vertical arm portion 52 and a horizontal arm portion 54 connected at right angles, and a guide slot 56 located on the vertical arm portion 52 and extended in a perpendicular manner relative to the axial direction of the guide shafts 30. The horizontal arm portion 54 defines a second support plane PL2 on a top side thereof. This second support plane PL2 is co-planar with the first support plane PL1 of the support member 40. In installation, the guide slot 56 of the auxiliary support arm 50 is coupled to the guide rod 44 of the support member 40, and where a torx bolt 58, or similar adjustable bolt, such as a star knobbed, wing nut/screw, etc., is inserted through the guide slot 56 of the auxiliary support arm 50 and the torx bolt 58 is threaded into the screw hole 42 of the support member 40. Thus, when the torx bolt 58 is loosened, the auxiliary support arm 50 is unlocked from the support member 40 and movable in a direction perpendicular to the axial direction of the guide shafts 30. When moving the auxiliary support arm 50 relative to the support member 40, the guide rod 44 provides good stability. When the torx bolt 58 is fastened, the auxiliary support arm 50 is locked to the support member 40 again.

In actual operation, the guide shafts 30 are moved axially to adjust the position of the support member 40 according to the length of the workpiece to be cut. After adjustment of the position of the support member 40, the first support plane PL1 of the support member 40 can thus bear the workpiece positively. If the width of the workpiece is excessive large and cannot be fully supported by the first support plane PL1 of the support member 40, the user can loosen the torx bolt 58, and then pull the auxiliary support arm 50 outwardly to a working position, and then tighten the torx bolt 58 to lock the auxiliary support arm 50 to the support member 40 in the working position, enabling the second support plane PL2 of the auxiliary support arm 50 to mate and coincide with the first support plane PL1 of the support member 40 for further supporting the large sized workpiece steadily. At this time, the user can operate the circular saw to move the saw blade to cut the workpiece while having proper support of the workpiece.

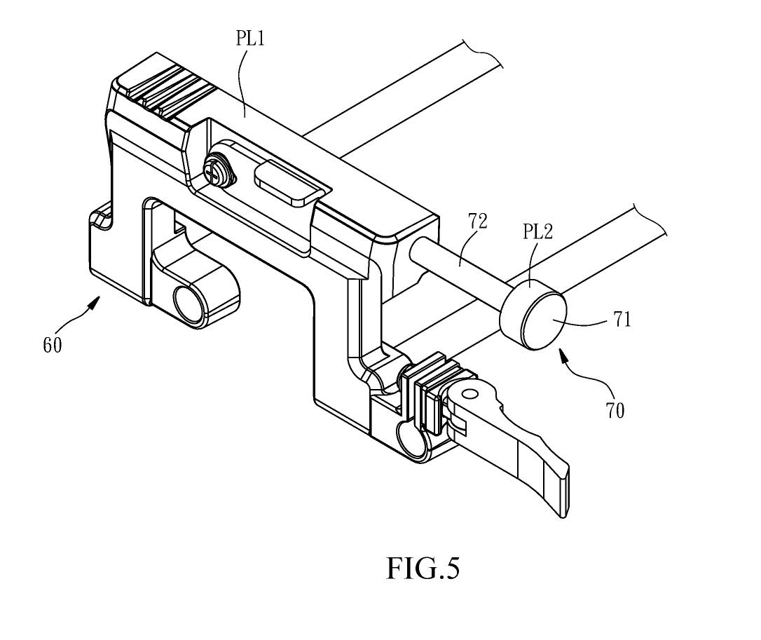

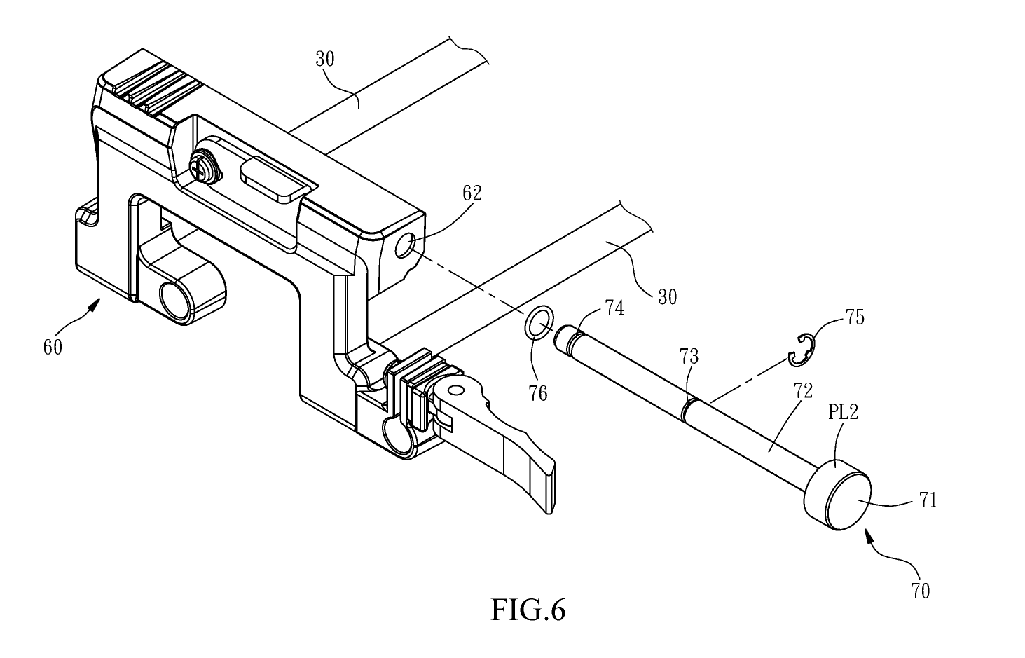

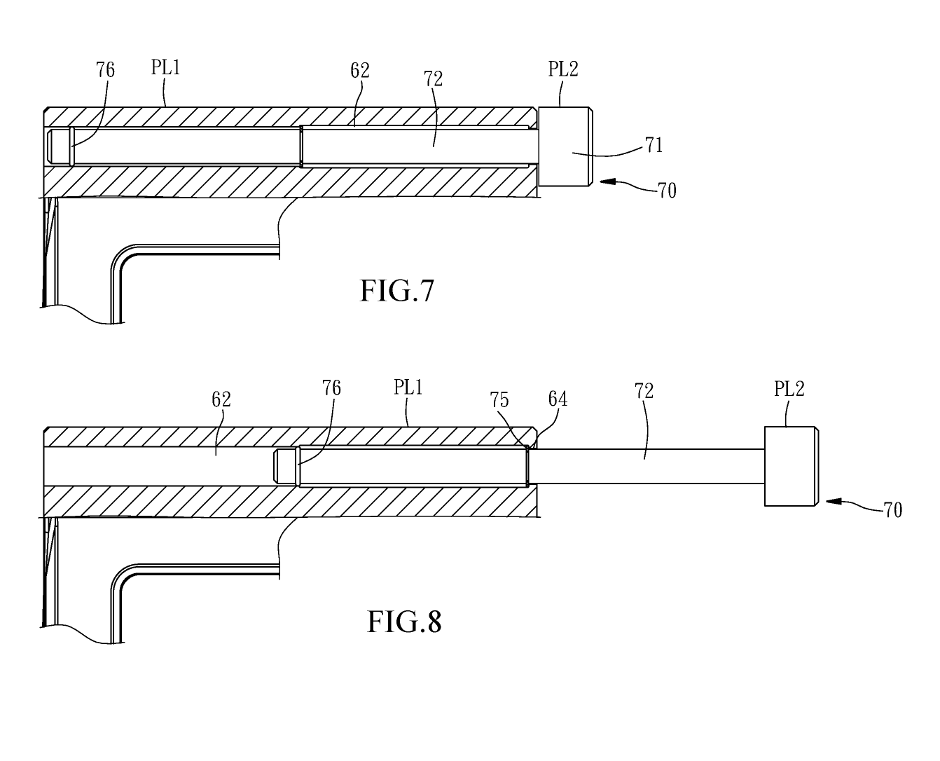

Referring to FIG. 5 and FIG. 6, in a second embodiment of the present invention, the support member, referenced by 60, comprises a through hole 62 located on a front side thereof, e.g., at one end of the support member 40, and a flange 64 extended around the through hole 62 (see FIG. 8). The axial direction of the through hole 62 extends perpendicular to the axial direction of the guide shafts 30. Further, in this second embodiment, the auxiliary support arm, referenced by 70, comprises a head 71 having a cylindrical shape, a geometric shape, or other shape that facilitates the support of a workpiece, and a shank 72 perpendicularly connected to one side of the head 71. The head 71 defines a second support plane PL2 on the periphery thereof. The shank 72 is inserted into the through hole 62 of the support member 60. As illustrated in FIGS. 6-8, the auxiliary support arm 70 further comprises a retainer groove 73 extended around the periphery of the shank 72 on the middle, a locating groove 74 extended around the periphery of the shank 72 near a distal end thereof remote from the head 71, a retaining ring 75 fastened to the retainer groove 73, and an elastic ring 76 fastened to the locating groove 74 and elastically abutted against the inner perimeter or surface of the through hole 62 of the support member 60 for producing a friction force to enhance the structural stability of the auxiliary support arm 70. When pulling the auxiliary support arm 70 outwardly to an outer limit position, the retaining ring 75 will be stopped by the flange 64 of the support member 60, preventing the shank 72 of the auxiliary support arm 70 from falling out of, e.g., being removed from, the through hole 62 of the support member 60.

From the aforesaid description we can know that if the width of the workpiece is excessively large and cannot be completely supported by the first support plane PL1 of the support member 60, the user can directly pull the auxiliary support arm 70 outwardly to an appropriate working position so that the second support plane P12 of the auxiliary support arm 70 can mate and coincide with the first support plane PL1 of the support member 60 to steadily support the large sized workpiece. At this time, the user can start operating the saw blade to cut the workpiece since the workpiece is properly supported.

In conclusion, the workpiece support device 20 has a simple structural arrangement, facilitates operation, and effectively assists the worktable 12 to provide good support to a large sized workpiece, to enhance working stability and precision cutting.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A workpiece support device connectable to a circular saw comprising a worktable, said worktable comprising a work surface, said workpiece support device comprising:
at least one guide shaft, each said guide shaft having one end thereof configured to be axially movably mounted in said worktable;
a support member mounted at an opposite end of said guide shaft, said support member comprising a first support plane, wherein when the workpiece support device is connected to the circular saw, the first support plane is co-planar with said work surface of said worktable; and
an auxiliary support arm mounted in said support member and movable relative to said support member along an operation direction perpendicular to the axial direction of said at least one guide shaft, said auxiliary support arm comprising a second support plane co-planar with said first support plane of said support member.

2. The workpiece support device as claimed in claim 1, wherein said support member comprises a screw hole extended in parallel to the axial direction of said at least one guide shaft; said auxiliary support arm comprises a guide slot extended perpendicular to the axial direction of said at least one guide shaft, and a screw bolt inserted through said guide slot and threadable into said screw hole of said support member to lock and unlock said auxiliary support arm to said support member.

3. The workpiece support device as claimed in claim 2, wherein said support member further comprises a guide rod disposed near said screw hole and inserted into said guide slot of said auxiliary support arm.

4. The workpiece support device as claimed in claim 2, wherein said auxiliary support arm comprises a vertical arm portion and a horizontal arm portion connected at right angles; said guide slot of said auxiliary support arm is located on said vertical arm portion; said second support plane is located on a top side of said horizontal arm portion.

5. The workpiece support device as claimed in claim 1, wherein said support member comprises a through hole extended perpendicular to the axial direction of said at least one guide shaft, and a flange extended around said through hole; said auxiliary support arm comprises a retainer groove extended around the periphery thereof, and a retaining ring mounted in said retainer groove and stoppable against said flange of said support member to prohibit said auxiliary support arm from falling out of said through hole.

6. The workpiece support device as claimed in claim 5, wherein said auxiliary support arm further comprises a locating groove extended around the periphery near one end thereof, and an elastic ring mounted in said locating groove and elastically abutted against an inner surface of said through hole.

7. The workpiece support device as claimed in claim 5, wherein said auxiliary support arm comprises a head, and a shank perpendicularly extended from one side of said head and inserted into said through hole of said support member; said second support plane is located on the periphery of said head of said auxiliary support arm.

8. A worktable for a circular saw comprising:
a work surface; and
a workpiece support device comprising:
at least one guide shaft, each said guide shaft having one end thereof axially movably mounted in said worktable;
a support member mounted at an opposite end of said guide shaft, said support member comprising a first support plane co-planar with said work surface of said worktable; and
an auxiliary support arm mounted in said support member and movable relative to said support member along an operation direction perpendicular to the axial direction of said at least one guide shaft, said auxiliary support arm comprising a second support plane co-planar with said first support plane of said support member.
